(19) United States
(12) Patent Application Publication
(10) Pub. No.: US 2025/0245276 A1
(43) Pub. Date: Jul. 31, 2025

(54) GENERATION OF DATA STORY RECOMMENDATIONS VIA ELICITED USER FEEDBACK

(71) Applicant: Adobe Inc., San Jose, CA (US)

(72) Inventors: Shunan GUO, San Jose, CA (US); Yeuk-Yin Chan, San Jose, CA (US); Ryan Rossi, San Jose, CA (US); Jane Elizabeth Hoffswell, Seattle, WA (US); Eunyee Koh, San Jose, CA (US); Guande Wu, Jersey City, NJ (US)

(21) Appl. No.: 18/422,665

(22) Filed: Jan. 25, 2024

(51) Int. Cl. G06F 16/9535

(52) U.S. Cl. CPC G06F 16/9535

(57) ABSTRACT

Methods, computer systems, computer-storage media, and graphical user interfaces are provided for facilitating generation of data story recommendations. In one implementation, a set of candidate data stories is generated. Each candidate data story can include various data visualizations. From the set of candidate data stories, a data story recommendation is determined based on an adaptive elicitation of user feedback via a set of inquiries selected in accordance with at least one potential reduction of the set of candidate data stories. Thereafter, the data story recommendation, including a set of data visualizations is provided for display.

### BACKGROUND

Data visualizations can provide a powerful way to convey information via a data story. In particular, visualizing data in a meaningful or compelling way can be influential and facilitate decision making. Many existing data analytics and visualization tools are sophisticated. Creating a meaningful, or compelling, data story using such visualization tools, however, can be difficult and tedious. For example, many data consumers have limited experience with data science and/or graphical designs making generation of data visualizations difficult. Further, an extensive amount of data and data visualizations can make it time consuming to identify specific data and an appropriate manner in which to present the data. Accordingly, although such existing data analytics and visualization tools are powerful, they may be difficult and inefficient for many data consumers to use.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, embodiments described herein facilitate automated generation of data story recommendations via elicited user feedback. In this regard, a user may provide or input feedback in response to inquiries and, based on the feedback, obtain an automatically generated data story recommendation. As such, a user only needs a high-level idea or understanding about the data, design, and/or insights desired and can provide such feedback in response to inquiries automatically provided to the user. In this way, the user need not have a strong understanding of the data or the visualization technologies in order to generate a meaningful data story.

At a high level, various implementations employ a conversational approach to facilitate generation of data story recommendations. In particular, a user may simply input responses to inquiries presented to the user via a user interface. The inquiries presented to a user can be selected in a manner that effectively reduces the number of candidate data stories available for selecting to recommend to the user. For example, an inquiry selected to present to a user may be the inquiry, from among a candidate set of inquiries, that most effectively reduces the number of candidate data stories available to recommend to the user. Inquiries may be selected and presented in a conversational or iterative manner such that a subsequent inquiry is selected for presentation based on a previous response to an inquiry. Based on user feedback obtained in response to inquiries presented to the user, the number of candidate data stories can be effectively reduced such that one or more remaining candidate data stories can be selected to present as a data story recommendation(s).

### BRIEF DESCRIPTION OF THE DRAWINGS

The technology described herein is described in detail below with reference to the attached drawing figures, wherein:

FIG. 1 is a block diagram of an exemplary system for facilitating generation of data story recommendations, suitable for use in implementing aspects of the technology described herein;

FIG. 2 is an example implementation for facilitating generation of data story recommendations, via a data story engine, in accordance with aspects of the technology described herein;

FIG. 3 provides an example of inquiry selection, in accordance with aspects of the technology described herein;

FIG. 4 provides an example of an iterative approach for inquiry selection and presentation, in accordance with aspects of the technology described herein;

FIG. 5 provide an example algorithm of an iterative approach related to generating data story recommendations, in accordance with aspects described herein;

FIG. 6 provides an example illustrative of an iterative approach to generate a data story recommendation, in accordance with aspects of the technology described herein;

FIG. 7 provides an example graphical user interface for providing a data story recommendation, in accordance with aspects of the technology described herein;

FIG. 8 provides an example implementation for providing a data story recommendation, in accordance with aspects of the technology described herein;

FIG. 9 provides an example method for facilitating generating of data story recommendations, in accordance with aspects of the technology described herein;

FIG. 10 provides another example method for facilitating generating of data story recommendations, in accordance with aspects of the technology described herein;

FIG. 11 provides another example method for facilitating generating of data story recommendations, in accordance with aspects of the technology described herein;

FIG. 12 provides another example method for facilitating generating of data story recommendations, in accordance with aspects of the technology described herein; and

FIG. 13 is a block diagram of an exemplary computing environment suitable for use in implementing aspects of the technology described herein.

### DETAILED DESCRIPTION

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

As data is becoming increasingly pervasive and plentiful, many individuals seek to use such data to provide meaningful data stories to others. Individuals oftentimes have unique perspectives and ideas on how to generate a meaningful story that includes various visualizations and/or captions to provide a story from data. Visualizing data in a meaningful or compelling way can be influential and facilitate decision making. For instance, such data stories can present data facts or insights together with narrative visualizations to support communication and decision making.

Many existing data analytic and visualization tools are sophisticated. Creating a meaningful, or compelling, data visualization using such visualization tools, however, can be difficult. For example, to create a compelling data story, an individual may need to go through a cumbersome workflow of exploring and analyzing the data to find relevant insights, arranging the insights in a meaningful order to make a story, and building a shareable artifact to present the story. Further, many data consumers have limited experience with data science and/or graphical designs. Accordingly, although such existing data analytics and visualization tools are powerful, they may be difficult and inefficient for many data consumers to use.

Such difficulties and inefficiencies may transpire at many steps in the data visualization workflow, including exploring data, identifying insights, and generating and customizing designs. By way of example, with regard to exploring data, users often have only high-level ideas of the desired information. However, conventional data visualization authoring tools require users to specify data fields for use in generating charts. It may be difficult for many users to map their high-level ideas to specific data fields. With regard to finding insights, statistical insights such as distributions, outliers, and correlations are one approach that users may use to drive data exploration and tell compelling stores. However, without data science knowledge and programming skills, it may be difficult for users to discover data insights. With regard to customizing charts, users often have evolving design needs. Initially, a user may desire to view a line chart. Subsequently, the user may desire to add filters and change colors. Existing tools require users to translate their high-level design concepts like “line chart” or “add a filter” to manual user interface actions, such as selecting button, selecting from a menu, etc. As another example, a strong chart title, highlighting, and annotations facilitate understanding a visualization. Adding highlighting and annotations is a tedious task, particularly when there are a lot of marks. For instance, using a mouse to select a particular line to highlight among numerous lines (e.g., 50+) may be difficult. Users, however, often do not have the expertise or time to learn sophisticated user interface tools.

Accordingly, manual visualization authoring tools that utilize a manual workflow for data exploration and visualization can be difficult and time consuming. As described, an analyst may need to select which variables to explore, decide what kind of visualization charts to use, inspect if useful insights exist, and repeat. Such tools may be too tedious for non-experts who have limited data science knowledge or graphic design skills.

To make the data story authoring process easier, automated technologies have been developed to generate data stories. Conventional data story generation tools often start with a user selecting an attribute from data and/or configuring parameters on a story generation model. Such input is generally limited and, oftentimes, results in undesired results. Upon receiving results, the user can interact with the user interface to make simple refinements to the data story. Such a trial-and-error approach, however, generally results in iterative modifications to attain the user's goals, thereby resulting in unnecessary utilization of computing device resources. Further, to make effective refinements, the user must understand intricacies of the underlying data and story generation algorithm.

As such, embodiments described herein facilitates automated generation of data story recommendations via elicited user feedback. In this regard, a user may provide or input feedback in response to inquiries and, based on the feedback, obtain an automatically generated data story recommendation. As such, a user only needs a high-level idea or understanding about the data, design, and/or insights desired and can provide such feedback in response to inquiries automatically provided to the user. Accordingly, the user need not have a strong understanding of the data or the visualization technologies in order to generate a meaningful data story.

At a high level, implementations described herein employ a conversational approach to facilitate generation of data story recommendations. In particular, a user may simply input responses to inquiries presented to the user via a user interface. The inquiries presented to a user can be selected in a manner that effectively reduces the number of candidate data stories available for selecting to recommend to the user. For example, an inquiry selected to present to a user may be the inquiry, from among a candidate set of inquiries, that most effectively reduces the number of candidate data stories available to recommend to the user. Inquiries may be selected and presented in a conversational or iterative manner such that a subsequent inquiry is selected for presentation based on a previous response to an inquiry. Based on user feedback obtained in response to inquiries presented to the user, the number of candidate data stories can be effectively reduced such that one or more remaining candidate data stories can be selected to present as a data story recommendation(s).

By way of example, as described in accordance with some embodiments, assume a data set is used to generate a set of candidate data stories available for providing as a data story recommendation. A first inquiry may be selected, from a set of candidate inquiries, and presented to a user based on the effectiveness of the inquiry to reduce the candidate data story set. Based on the user feedback provided in response to the first inquiry, the set of candidate data stories is reduced in accordance with the user feedback and a second inquiry is selected based on the effectiveness to continue reducing the candidate data story set. The iterative approach of selecting an inquiry, receiving user feedback for the inquiry, and using the user feedback to reduce the set of candidate data stories can be used to reduce the candidate data story set to a limited or reasonable number of candidate data stories from which one or more candidate data stories can be selected to present as a data story recommendation(s). In this regard, implementations described herein use a conversational approach to identify user's interests and provide a relevant or desired data story recommendation. Stated differently, user feedback can be adaptively collected and used to guide data story recommendations. Further, the inquiries and user feedback may pertain to content attributes and/or structure attributes, such that the data story recommendation aligns with a user's content and structure preferences. In this way, embodiments provided herein describe a mixed-initiative data story generation workflow that incorporates a user's preferences into a data story recommendation through conversational inquiries and responses.

Advantageously, embodiments described herein facilitate efficient and effective generation of data story recommendations. In particular, the technology described herein enables usage of a reduced amount of computing resources as it more specifically analyzes aspects of interest to a user (e.g., via elicited user feedback). Importantly, it does so without reducing the effectiveness or breadth of possible attributes of interest. For example, user feedback can be elicited for content feedback indicating desired content to be viewed and structure feedback indicating desired structure associated with the data story. User feedback can be elicited in an iterative manner directed to more fine-grained data story specifications, for example, related to a particular data attribute or preferred narrative structure. In this way, a user may be presented with a data story that targets desired aspects specifically selected of interest to the user. Further, to propose inquiries to elicit the user's analysis intention both informatively and efficiently, inquiry optimization (e.g., Pareto Frontier Optimization) can be used to ensure necessary information is gathered with a minimum number of inquiries proposed to the user. In this way, inquiry optimization facilitates a more efficient reduction of the number of candidate data stories, thereby reducing computer resource utilization needed to analyze candidate data stories for providing as a data story recommendation. Enabling elicitation of a minimum number of inquiries further decreases computing resource utilization required to present inquiries and process user feedback.

Various terms are used throughout the description of embodiments provided herein. A brief overview of such terms and phrases is provided here for ease of understanding, but more details of these terms and phrases is provided throughout.

A data story generally refers to a manner in which to present data in a visually appealing and easy-to-understand manner related to a topic or to provide a visual story of data. A data story may include any number of data visualizations to convey information. A data visualization generally refers to any visualization of data that can illustrate data and provide insights associated therewith. For example, data visualizations may include charts, graphs, facts, and/or insights corresponding therewith. In this regard, a set or collection of data visualizations may be used to present a story regarding a topic.

A candidate data story refers to a data story that is a candidate or potential data story to provide as a recommendation. Candidate data stories can be automatically generated in accordance with a dataset (e.g., a user-selected dataset).

A data story recommendation refers to a data story, selected from among candidate data stories, that is provided or to be provided for display to a user. In this regard, a data story recommendation is a recommended data story that is determined to be of interest to the user.

An inquiry refers to an inquiry or question presented to a user to elicit user feedback. In various embodiments described herein, the inquiries include response options that prompt the user for feedback in accordance with one or more response options associated with the inquiry.

### Overview of Exemplary Environments for Facilitating Generation of Data Story Recommendations Via Elicited User Feedback

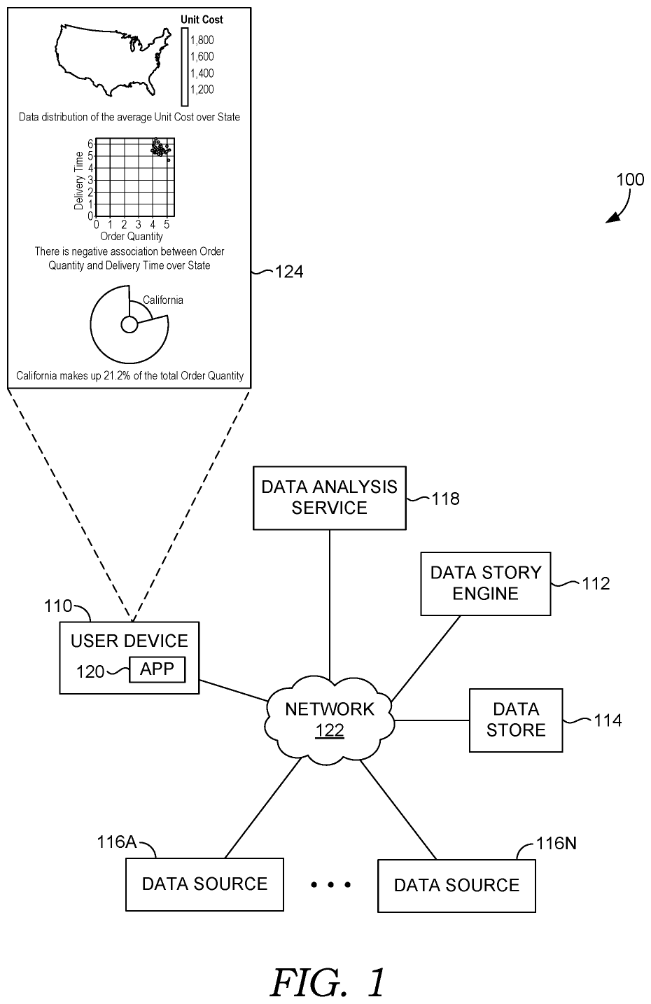

Referring initially to FIG. 1, a block diagram of an exemplary network environment 100 suitable for use in implementing embodiments described herein is shown. Generally, the system 100 illustrates an environment suitable for facilitating generation of data story recommendations via elicited user feedback. Among other things, embodiments described herein effectively and efficiently identify or recommend a data story(s) in accordance with user feedback provided by a user in response to a set of inquiries provided to the user. In this regard, in response to an inquiry(s), a user can input or provide preferences related to content and/or structure associated with a desired data story and, based on the input, be automatically provided with a corresponding data story, or recommendation thereof. A data story generally refers to a manner in which to present data in a visually appealing and easy-to-understand manner related to a topic. Generally, a data story may include any number of data visualizations to convey information. A data visualization generally refers to any visualization of data that can illustrate data and insights associated therewith. For example, data visualizations may include charts, graphs, facts, and/or insights corresponding therewith. In this regard, a set or collection of data visualizations may be used to present a story regarding a topic.

In FIG. 1, the network environment 100 includes a user device 110, a data story engine 112, a data store 114, data sources 116a-116n (referred to generally as data source(s) 116), and a data analysis service 118. The user device 110, the data story engine 112, the data store 114, the data sources 116a-116n, and the data analysis service 118 can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document. Neither should the exemplary network environment 100 be interpreted as having any dependency or requirement related to any single component or combination of components illustrated therein. For example, the user device 110 and data sources 116a-116n may be in communication with the data story engine 112 via a mobile network or the Internet, and the data story engine 112 may be in communication with data store 114 via a local area network. Further, although the environment 100 is illustrated with a network, one or more of the components may directly communicate with one another, for example, via HDMI (high-definition multimedia interface), and DVI (digital visual interface). Alternatively, one or more components may be integrated with one another, for example, at least a portion of the data story engine 112 and/or data store 114 may be integrated with the user device 110 and/or data analysis service 118. For instance, a portion of the data story engine 112 may be integrated with a server (e.g., data analysis service) in communication with a user device, while another portion of the data story engine 112 may be integrated with the user device (e.g., via application 120).

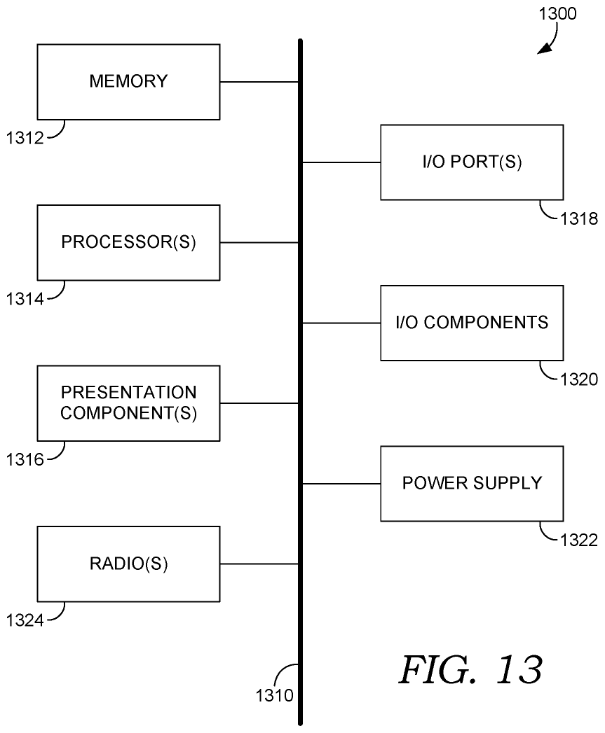

The user device 110 can be any kind of computing device capable of facilitating data story recommendations via elicited user feedback. For example, in an embodiment, the user device 110 can be a computing device such as computing device 1300, as described above with reference to FIG. 13. In embodiments, the user device 110 can be a personal computer (PC), a laptop computer, a workstation, a mobile computing device, a PDA, a cell phone, or the like.

The user device can include one or more processors, and one or more computer-readable media. The computer-readable media may include computer-readable instructions executable by the one or more processors. The instructions may be embodied by one or more applications, such as application 120 shown in FIG. 1. The application(s) may generally be any application capable of facilitating data story recommendations via elicited user feedback. In some implementations, the application(s) comprises a web application, which can run in a web browser, and could be hosted at least partially server-side (e.g., via data story engine 112 or data analysis service 118). In addition, or instead, the application(s) can comprise a dedicated application. In some cases, the application is integrated into the operating system (e.g., as a service). As one specific example application, application 120 may be a visual design tool or other data analysis tool that provides various data and data visualizations. Such an application may be accessed via a mobile application, a web application, or the like.

User device 110 can be a client device on a client-side of operating environment 100, while data story engine 112 and/or data analysis service 118 can be on a server-side of operating environment 100. Data story engine 112 and/or data analysis service 118 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted there is no requirement for each implementation that any combination of user device 110, data story engine 112, and/or data analysis service 118 to remain as separate entities.

In an embodiment, the user device 110 is separate and distinct from the data story engine 112, the data store 114, the data source(s) 116, and the data analysis service 118 illustrated in FIG. 1. In another embodiment, the user device 110 is integrated with one or more illustrated components. For instance, the user device 110 may incorporate functionality described in relation to the data story engine 112. For clarity of explanation, embodiments are described herein in which the user device 110, the data story engine 112, the data store 114, the data source(s) 116, and the data analysis service 118 are separate, while understanding that this may not be the case in various configurations contemplated.

As described, a user device, such as user device 110, can facilitate generation of data story recommendations via elicited user feedback. As described, a data story recommendation refers to a recommended data story that corresponds with obtained user feedback. A data story may include any number of data visualizations to convey a data story associated with a data set. A data visualization is broadly used herein and may refer to any visual designs and/or insights associated with a dataset(s).

A user device 110, as described herein, is generally operated by an individual or entity interested in viewing a data story(s) or visualizations of data (e.g., in the form of graphs, charts, insights, etc.). As can be appreciated, a user interested in viewing data stories need not be an individual or entity associated with capturing or providing a dataset from which the data visualizations are generated. For example, in some cases, a user desiring to view data visualizations may be an individual gathering insights of trends of data provided by another entity (e.g., in a collaborative environment or obtained via the Internet).

In some cases, an automated data story recommendation(s) may be initiated at the user device 110. For example, a user may input, provide, or select a data set from which to generate a data story recommendation(s). Additionally or alternatively, a user may select a button, icon, or other indicator presented via a graphical user interface to initiate viewing of a data story recommendation. As another example, generation of data store recommendations may be automatically initiated based on a user accessing application 120 (e.g., a data analytics application), a user opening or uploading a data set, and/or the like. Initiating generation of data story recommendations can be performed in any number of ways and is not intended to be limited herein.

As can be appreciated, in some cases, a user of the user device 110 that may initiate generation of a data story recommendation(s) is a user that can view the data story. In additional or alternative cases, an administrator, programmer, or other individual associated with an organization may initiate generation of a data story recommendation, but not necessarily be a consumer or viewer of the data story.

As described herein, in accordance with initiating generation of a data story recommendation(s), a set of inquiries can be presented to a user to obtain user preferences related to content and/or structure of a data story. In embodiments, the inquiries are presented in a sequential manner such that a subsequent inquiry prompt is based on a response or feedback in relation to a previous inquiry. The inquiries are generally presented to the user for obtaining feedback via application 120 of user device 110. In this way, as inquiries are displayed to a user via application 120, the application 120 can obtain user input or feedback to the inquiries. In this regard, the user device 110, via an application 120, might allow a user to input, select, or otherwise provide user feedback in response to one or more inquiries. The application 120 may facilitate inputting of user feedback in a verbal form of communication or a textual form of communication. The user device 110 can include any type of application and may be a stand-alone application, a mobile application, a web application, or the like. In some cases, the functionality described herein may be integrated directly with an application or may be an add-on, or plug-in, to an application.

The user feedback may be provided in any of a number of ways. In some cases, user feedback is provided as a selection of one or more options from among a set of options related to an inquiry. For example, an inquiry may be in the form of a multiple choice question of which one or more options may be selected to provide user feedback. In other cases, user feedback may be obtained in the form of a natural language feedback or response. In this regard, a user can speak or type at will to provide aspects of a desired data story content and/or structure.

The user device 110 can communicate with the data story engine 112 to provide user feedback, initiate generation of data story recommendations, and/or obtain data stories or recommendations associated therewith. In embodiments, for example, a user may utilize the user device 110 to initiate generation of a data story recommendation via the network 122. For instance, in some embodiments, the network 122 might be the Internet, and the user device 110 interacts with the data story engine 112 (e.g., directly or via data analysis service 118) to initiate generation of a data story recommendation. In other embodiments, for example, the network 122 might be an enterprise network associated with an organization. It should be apparent to those having skill in the relevant arts that any number of other implementation scenarios may be possible as well.

With continued reference to FIG. 1, the data story engine 112 can be implemented as server systems, program modules, virtual machines, components of a server or servers, networks, and the like. At a high level, the data story engine 112 manages generation of data story recommendations. In particular, the data story engine 112 can obtain data from data source(s) 116 and user feedback in response to inquiries from user device 110. Data sources 116a-116n may be any type of source providing data used to generate data visualizations and/or data stories. Generally, the data story engine 112 can receive user feedback and/or visualization data from any number of devices. As such, the data story engine 112 can identify and/or collect data from various user devices, such as user device 110, and sources, such as data sources 116a-116n. In this regard, the data story engine 112 can retrieve or receive data collected or identified at various components, or sensors associated therewith.

As described, in some embodiments, the data story engine 112 can use visualization data (e.g., obtained via data source(s) 116) to generate candidate data stories. Visualization data generally refers to any data that can be used to generate a data story, or data visualization. By way of example only, visualization data may include a dataset from which a data visualization(s) of a data story is generated, such as a preconfigured data table from which a data visualization for a data story is generated. A dataset used for forming a data visualization can be any type of data. By way of example and not limitation, data within a dataset may include data that is sensed or determined from one or more sensors, collected via surveys, observed data, or nearly any other type of data that may be used to generate data visualizations as described herein.

Such visualization data can be initially collected at remote locations or systems and transmitted to data store 114 for access by data story engine 112. In accordance with embodiments described herein, visualization data collection may occur at data sources 116. In some cases, data source(s) 116, or portion thereof, may be user devices, that is, computing devices operated by a user. As such, user devices, or components associated therewith, can be used to collect various types of visualization data. For example, in some embodiments, visualization data may be obtained and collected at a user device via one or more sensors, which may be on or associated with one or more user devices and/or other computing devices. As used herein, a sensor may include a function, routine, component, or combination thereof for sensing, detecting, or otherwise obtaining information, such as visualization data, and may be embodied as hardware, software, or both.

In addition or in the alternative to data sources 116 including user devices, data source(s) 116 may include servers, data stores, or other components that collect visualization data, for example, from user devices. For example, in interacting with a user device, datasets may be captured at data source(s) 116 and, thereafter, such visualization data can be provided to the data store 114 and/or data story engine 112. In this regard, dataset contributors may operate a client device and provide a dataset to the data source 116. Although generally discussed as visualization data provided to the data store 114 and/or data story engine 112 via data source(s) 116 (e.g., a user device or server, data store, or other component in communication with user device), visualization data may additionally or alternatively be obtained at and provided from the data analysis service 118, or other external server, for example, that collects visualization data. Visualization data can be obtained at a data source periodically or in an ongoing manner (or at any time) and provided to the data store 114 and/or data story engine 112 to facilitate generation of data story recommendations.

As described, the data story engine 112 can receive user feedback for generating data story recommendations via the user device 110 (or other device). User feedback received from a device, such as user device 110, can include various attribute indications (e.g., content attributes and/or structure attributes) manually or explicitly input by the user (e.g., input selections of presented options). Generally, the data story engine 112 can receive user feedback from any number of devices. In accordance with receiving elicited user feedback (e.g., via the user device 110), the data story engine 112 can analyze data story candidates to generate a data story recommendation(s). In this regard, the user feedback is used to determine which candidate data story(s) to provide as a data story recommendation(s) to the user.

In some cases, the recommended data story(s) can be provided to the user device 110 for display to the user. In other cases, the data analysis service 118 may use such data to perform further analysis and/or render or provide data stories to the user device 110. For instance, the data analysis service 118 can reference a data story recommendation(s) and use such data to perform further analysis and/or provide the data story recommendation(s) to the user device 110. The data analysis service 118 may be any type of server or service that can analyze data, render data, and/or provide information to user devices. Although data analysis service 118 is shown separate from the data story engine 112, as can be appreciated, the data story engine 112 can be integrated with the data analysis service 118, or other service or services. The user device 110 can present received data (e.g., data story recommendation) or information in any number of ways, and is not intended to be limited herein. As one example, a data story recommendation 124 can be presented via application 120 of the user device.

Advantageously, utilizing implementations described herein enable generation of data story recommendations to be performed in an efficient and more accurate manner (e.g., in accordance with user desires). Further, the data story recommendation(s) can dynamically adapt to align with information desired by the user. As such, a user can view desired information and can assess the information accordingly. Further, the inquiries that elicit user feedback are designed and selected in a manner to efficiently analyze candidate data stories and generate a data story recommendation(s). In embodiments, the user can iteratively update or supplement input to obtain at a desired data story automatically generated.

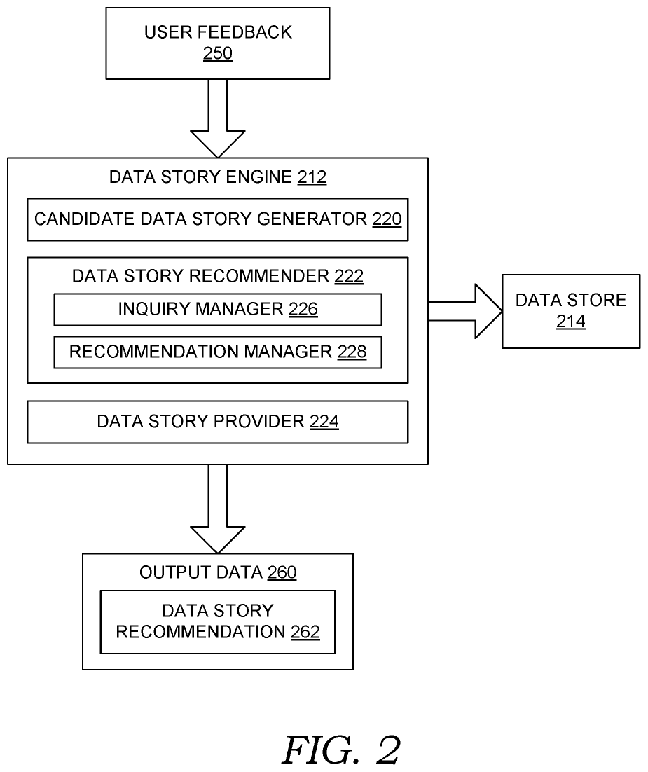

Turning now to FIG. 2, FIG. 2 illustrates an example implementation for facilitating data story recommendations based on elicited user feedback, via data story engine 212. The data story engine 212 can communicate with the data store 214. The data store 214 is configured to store various types of information accessible by the data story engine 212, or other server or component. In embodiments, data sources (such as data source(s) 116 of FIG. 1), user devices (such as user device 110 of FIG. 1), and/or data story engine 212 can provide data to the data store 214 for storage, which may be retrieved or referenced by any such component. As such, the data store 214 may store inquiries, user feedback, candidate data stories, datasets, data story recommendations, and/or the like.

In operation, the data story engine 212 is generally configured to manage generation of data story recommendations. In embodiments, the data story engine 212 includes a candidate data story generator 220, a data story recommender 222, and a data story provider 224. According to embodiments described herein, the data story engine 212 can include any number of other components not illustrated. In some embodiments, one or more of the illustrated components 220, 222, and 224 can be integrated into a single component or can be divided into a number of different components. Components 220, 222, and 224 can be implemented on any number of machines and can be integrated, as desired, with any number of other functionalities or services.

The candidate data story generator 220 is generally configured to generate candidate data stories. Candidate data stories refers to potential data stories that may be identified or selected as a data story recommendation. As described, generation of candidate data stories may be initiated in any of a number of ways. For example, a user may select to view one or more data story recommendations via a user device. As another example, a user may select to analyze a particular dataset via a user device. For instance, in some cases, candidate data stories may be generated upon obtaining a dataset or obtaining an update to the dataset. In some cases, such candidate data stories may be stored for subsequent use (e.g., to generate data story recommendations). In other cases, initiation of candidate data stories generation may occur in accordance with a lapse of a time duration (e.g., every 24 hours a set of candidate data stories is generated and stored for subsequent use). In yet other cases, candidate data stories may be generated in response to a user selection or other detected event that initiates candidate data story generation (e.g., user access of a dataset, a user indication to analyze a dataset, a user indication to view data story recommendations, etc.).

Generally, as described herein, candidate data stories are generated in accordance with a dataset(s). In this regard, a particular dataset may be used to generate candidate data stories associated therewith. The particular dataset to use for generating candidate data stories may be user selected. For example, in some cases, a user may navigate to or upload a particular dataset and indicate utilization of the dataset for viewing data story recommendations. The dataset for use in generating candidate data stories may be any type of data and is not intended to be limited herein.

In accordance with identifying a dataset for use in generating candidate data stories, the dataset may be accessed or obtained (e.g., via a data store or other data source). Such visualization data can be accessed via data store 214, which may obtain visualization data from any number of devices, including data sources such as data contributor devices. For example, a data contributor device used by a data contributor may provide a dataset that may be used for generating data visualizations. A data contributor may be an individual or entity that publishes data (e.g., cleaned data tables) for utilization. In some cases, a data contributor may be the same as, or related to, a user initiating a data visualization generation. In other cases, a data contributor may be a third-party to a user initiating a data visualization generation. For instance, a data contributor may be an entity that publishes cleaned data tables for public reuse. Such data can be stored in the data store (e.g., via an index or lookup system) for subsequent utilization by the data story engine 212. Although described as accessing visualization data from data store 214, visualization data can alternatively or additionally be obtained from other components, such as, for example, directly from contributor devices or servers in communication with contributors devices, another data store, or the like.

In some cases, candidate data stories may be generated in accordance with user preferences. For example, a user may input a query (e.g., a natural language query) indicating one or more preferences for generating candidate data stories. A natural language query, or portions thereof, may be input, selected, or otherwise provided in a textual form or a verbal form via a user interface. Such natural language queries may indicate a manner in which to tailor or customize data visualizations. For instance, a user may indicate information related to desired data, visual design, and/or insight for a data visualization(s) to include in a data story via a natural language query in unstructured form. The natural language query may be or include a command, a question, a list of words and phrases, or the like. As can be appreciated, the natural language query may include any number of details related to various visualization aspects, such as data, visual design, and/or insight. As one example, a natural language query may be more general or vague. As another example, a natural language query may be more specific. As another example, user preferences, such as default user preferences, may be obtained and used to generate candidate stories. For instance, a user profile generated for the user may include one or more user preferences related to candidate data story generation.

As can be appreciated, any number of candidate data stories may be generated. By way of example, 100 candidate data stories may be generated. In some cases, the number of candidate data stories may be a predefined or default number of data stories (e.g., user defined or system defined). In other cases, the number of candidate data stories generated may be based on the dataset (e.g., type of data in the dataset, amount of data in the dataset, etc.). Candidate data stories may include any number, combination, and order of data visualizations. For example, a first candidate data story may include five data visualizations, a second candidate data story may include four data visualizations, and a third candidate data story may include two data visualizations.

Candidate data story generation may be performed in any number of ways. As one example, a set of data story candidates S are generated using a sequential data story generation algorithm designed to ensure the data story candidates satisfy logicality, integrity, and insight diversity. Logicality measures the transition coherence (e.g., commonness in data subspace, measure, breakdown, and insight type) between adjacent data visualizations. Integrity measures the data coverage of a particular data story to prevent drilldown fallacy. Diversity ensures the variance of data visualizations in the story. In some cases, a Monte Carlo Tree Search (MCTS) is used to generate an insight sequence that achieves the best score in terms of various metrics, including logicality, integrity, and diversity. MCTS is generally a heuristic search algorithm that searches a tree using Monte-Carlo simulations as state evaluations to solve decision processes. In some cases, to accelerate candidate data story generation, Monte Carlo Tree Search (MCTS) approach is used with a beam search algorithm. A beam search may include a heuristic search algorithm that explores a graph by expanding a most promising node in a limited set of nodes, referred to as the beam width.

In accordance with generating candidate data stories, in some cases, the candidate data stories may be stored, for example, at data store 214. For instance, in some cases, candidate data stories may be generated upon obtaining a dataset or obtaining an update to the dataset and stored for subsequent use (e.g., to generate data story recommendations). In other cases, candidate data stories may be generated in accordance with a lapse of a time duration (e.g., every 24 hours a set of candidate data stories is generated and stored for subsequent use). In yet other cases, candidate data stories may be generated in response to a user selection or other detected event that initiates candidate data story generation (e.g., user access of a dataset, a user indication to analyze a dataset, a user indication to view data story recommendations, etc.).

The data story recommender 222 is generally configured to manage or recommend data stories. In this regard, the data story recommender 222 analyzes the candidate data stories to generate a data story recommendation(s). As described herein, the data story recommender 222 generally analyzes the candidate data stories in association with user feedback elicited via various inquiries. Such inquiries are selected in an efficient and effective manner and may pertain to content and/or structure such that different types of user feedback can be obtained. In this way, the data story recommendation(s) is based on content and/or structure desired or preferred by the user, which is captured in a clear and concise manner.

As shown, the data story recommender 222 includes an inquiry manager 226 and a recommendation manager 228. Any number of components may be used to implement functionality described herein, and is not intended to be limited to the specific components described herein.

The inquiry manager 226 is generally configured to manage inquiries provided to elicit user feedback. As described, a set of inquiries is provided to a user to elicit user feedback 250 used to generate data story recommendations. Inquiries are generally directed to various attributes that may be associated with a data story. As described herein, attributes may represent different types of information, such as content and structure. For example, content attributes are generally attributes that represent content in association with a data story, such as a data visualization. One example of content attributes includes dimension or entity attributes. Dimension or entity attributes generally refer to the different dimensions or types of data in a dataset. For example, for a dataset that includes revenue data, profit data, and expense data, a first dimension attribute may represent revenue data, a second dimension attribute may represent profit data, and a third dimension attribute may represent expense data. Structure attributes generally refers to attributes that represent structure associated with a data story, such as data visualizations. Example structure attributes may include types of insights, types of visual designs, order of data visualizations, etc. Advantageously, including candidate inquiries that relate to content and structure enable inquiries to be selected that may capture a user desired data story recommendation in terms of both content and structure.

Inquiries may be presented in various formats. Example of inquiry formats include a comparison format, a rating format, and an interest format. A comparison format generally refers to an inquiry that compares a pair of attributes. For example, a comparison inquiry may inquire as to preference of attribute A or attribute B. A rating format generally refers to an inquiry that rates or otherwise indicates a level of interest for a particular attribute. For example, a rating inquiry may inquire as to a level of interest of attribute A. An interest format generally refers to an inquiry that inquires as to which attribute, from multiple attributes, in which the user is interested or uninterested. As can be appreciated, each type of inquiry format may represent a content attribute(s) or a structure attribute(s). For example, in some cases, a comparison format can be used to compare a first content attribute and a second content attribute. Alternatively or additionally, a comparison format can be used to compare a first structure attribute and a second structure attribute. In yet other cases, a content attribute(s) may be compared to a structure attribute(s).

The inquiry manager 226 generally selects or identifies inquiries to be provided to a user to obtain a user preference or response. Selecting or identifying an inquiry(s) to present to a user can be performed in any of a number of ways. In some embodiments, an inquiry(s) to present to a user may be selected from among a set of candidate inquiries. Candidate inquiries can be generated in any of a number of ways. In some cases, candidate inquiries may be input or selected. For example, a developer or entity implementing or managing a data story engine may input candidate inquiries. As another example, a provider or manager of the dataset may input a set of candidate inquiries associated with the dataset.

In yet other cases, candidate inquiries may be automatically generated based on the dataset. As described herein, inquiries may be presented in various formats. Examples of inquiry forms include a comparison format, a rating format, and an interest format. In such a case, inquiries that represent each of the various inquiry formats may be generated. By way of example only, assume a set of ten attributes are identified in association with a dataset. Although attributes may include content attributes and/or structure attributes, in this example, let's assume the ten attributes are dimension attributes representing various dimensions in the dataset. In such a case, a set of comparison format inquiries may be generated that compare different pairs of the dimension attributes. For example, candidate inquiries can be generated that compare each unique pair of dimension attributes. Further, a set of rating format inquiries may be generated that inquire as to level of interest for each particular attribute. In this case, ten rating format inquiries may be generated to represent the ten different dimensions. In addition, a set of interest format inquiries may be generated that compare combinations of attributes. For instance, for multiple-choice questions representing three different attributes, various combinations of three attributes may be used to generate corresponding inquiries. As can be appreciated, similar candidate inquiries may be generated for other types of content attributes and/or structure attributes. In some cases, a particular inquiry may focus on only structure attributes and, accordingly, only the structure attributes are compared or reflected in a particular inquiry. Similarly, a particular inquiry may focus on only content attributes and, accordingly, only content attributes are compared or reflected in a particular inquiry.

In some embodiments, inquiries are selected or identified, for example, from a set of candidate inquiries, in a manner so as to elicit feedback that effectively reduces the number of candidate data stories. Stated differently, an inquiry(s) may be selected in a way that minimizes the candidate data stories most effectively. In one implementation, each inquiry may be evaluated based on potential feedback or responses that may be taken given a set of response options associated with the inquiry. For example, assume an inquiry is in the form of a multiple-choice inquiry with three options for a user response. In such a case, the potential or simulated feedback associated with the response options can be analyzed to evaluate effectiveness of reducing the candidate data stories. One implementation for employing a simulation-based analysis includes a Monte-Carlo approach, which is a simulation-based approach to evaluate candidate inquiries.

As described, to evaluate candidate inquiries, potential responses can be analyzed to identify effectiveness of reducing the set of candidate data stories. In some cases, a candidate inquiry that removes the most candidate data stories from a set of candidate data stories or that reduces the set of candidate data stories the most is selected for presentation to a user. At a high level, one approach includes identifying a candidate inquiry score that aggregates candidate data story reduction for each potential response associated with a candidate inquiry. For example, assume a candidate inquiry includes three potential responses. To identify a candidate inquiry score for that candidate inquiry, a first number of candidate data story reductions is identified in the event the first response is selected, a second number of candidate data story reductions is identified in the event the second response is selected, and a third number of candidate data story reductions is identified in the event the third response is selected. The numbers representing the three different candidate data story reductions based on corresponding simulated responses can be aggregated to generate a candidate inquiry score. In some cases, the aggregation includes averaging the various candidate data story reductions associated with the corresponding simulated responses. For instance, and continuing with this example, assume a simulated selection of the first response would result in reducing the set of candidate data stories by two, a simulated selection of the second response would result in reducing the set of candidate data stories by 10, and a simulated selection of the third response would result in reducing the set of candidate data stories by 12. In such a case, the candidate inquiry score for the candidate inquiry is “8,” the average of the candidate data stories reductions of 2, 10, and 12. Candidate inquiry scores for each candidate inquiry may be determined in a similar manner and, thereafter, used to select an inquiry to present to the user. For instance, the candidate inquiry associated with the greatest or highest candidate inquiry score may be selected for presenting to the user, as the greatest candidate inquiry score corresponds with the candidate inquiry likely to reduce the set of candidate data stories. Although average of candidate data story reductions is provided herein as one manner for identifying candidate inquiry scores, other methods may be used, such as, for example, a total number of candidate data story reductions, a median number of candidate data story reductions, etc.

In one embodiment, inquiry selection is performed in a manner that optimally reduces the size of the Pareto frontier, represented as S*. A Pareto frontier refers to a set of all Pareto efficient solutions. Stated differently, the Pareto frontier represents a set of candidate stories that outperforms other candidates. In some cases, the inquiry manager 226 exploits a Monte-Carlo strategy, as described above, to compute an expected E data story number S* of inquiry candidate q as follows:

$$E [ \vert {S}^{*} ‖ q , m ] = \sum p ( a \vert q , m ) * \vert {S}^{*} ( qa ( m ) ) \vert$$

In this example, E[|S*∥q,m] indicates the Pareto frontier, |S*|'s, conditional expectation based on the inquiry candidate m. In this example, a uniform distribution

$$p ( a \vert q , {m}_{b} ) = \frac{1}{{N}_{a}}$$

is used, where Nₐ is the number of the possible responses or response options. For example, in cases that two response options are associated with a candidate inquiry, a uniform distribution of 0.5 is used as the probability associated with each response. As described, the expected value for a candidate inquiry q is determined by average of data story number size S* for each potential response a. As can be appreciated, other methods may be used to identify or determine the distribution p, as opposed to using a uniform distribution.

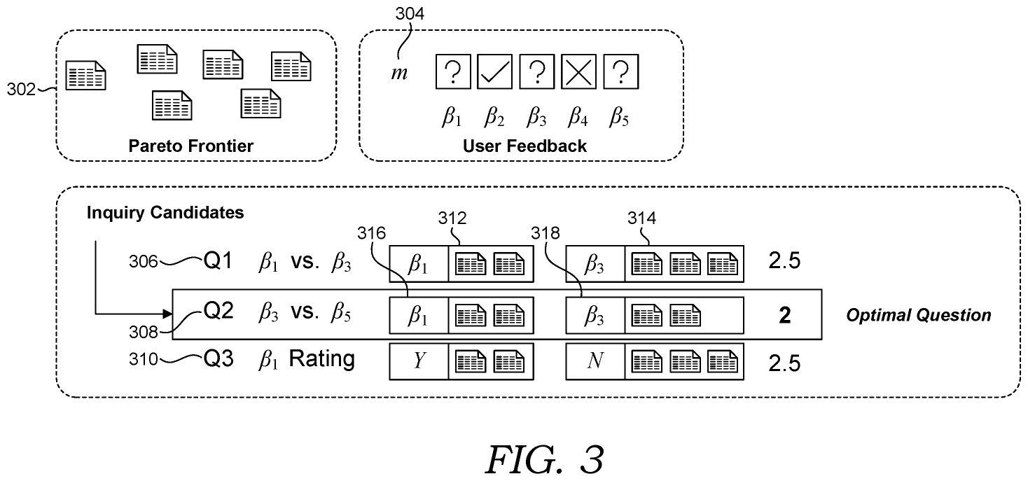

By way of example only, and with reference to FIG. 3, assume a Pareto frontier of inquiries 302 exists. Further assume in this example, that use feedback 304 has already been collected indicating a user interest in attribute 2 and uninterested in attribute 4. In this regard, candidate inquiries related to attributes 1, 3, and 5 may be analyzed. As such, candidate inquiries 306, 308, and 310 are analyzed. With respect to inquiry 306, two attributes are indicated as response options. An expected candidate data story size is 2 if attribute one is selected (i.e., as shown at 312) and an expected candidate data story size is 3 if attribute 3 is selected (i.e., as shown at 314), resulting in an average of 2.5 candidate data stories. With regard to inquiry 308, two attributes are indicated as response options. An expected candidate data story size is 2 if attribute 3 is selected (i.e., as shown at 316) and an expected candidate data story size is 2 if attribute 5 is selected (e.g., as shown at 318), resulting in an average of 2 candidate stories. In this example, the expected candidate data story size of 2, in association with inquiry 308 is the smallest and, as such, is selected to present to the user.

The selected candidate inquiry is provided for presentation to the user. In this regard, the inquiry manager 226 may provide an inquiry to the user device for display to the user. The inquiry includes the response options for selection by a user. In this way, as a user selects a response option for the inquiry, the inquiry manager 226 obtains the response. Such user feedback may be stored, for example via data store 214.

As described herein, the user feedback to the inquiries can be used to reduce the set of candidate data stories. As such, in some embodiments, the inquiry manager 226 may use the user feedback to designate or update attribute interest value(s) indicating an extent of interest associated with corresponding attribute(s). An attribute interest value generally refers to any value used to represent or indicate an extent of interest in a particular attribute. For example, a first attribute may be associated with a first attribute interest value, and a second attribute may be associated with a second attribute interest value.

In one embodiment, an attribute interest value is generated for attributes to capture user feedback across attributes. In some cases, a set of attributes are identified. As described above, the attributes may include content attributes and/or structure attributes. In some cases, the attributes correspond with the attributes used for candidate inquiry generation. As one example for identifying attributes, given an input dataset, a set of potential attributes may be identified, which may be denoted as L={l₁, l₂, l₃, . . . , lⱼ, . . . , l_{J}}. In some cases, each attribute may be weighted differently for each data story candidate.

As described, user feedback is obtained, in response to inquiries presented to the user, that indicates the user's preferences on the attributes L denoted as m={β₁, β₂, . . . ,βⱼ, . . . , β_{J}}. In some cases, βⱼ∈{−1,0,1} represents the user's feedback related to attribute lⱼ. These values allows users to express their preferences for including (e.g., β=1) or excluding (e.g., β=−1) specific information from the data story. Any set of values, however, may be used and these are only provided as one example.

As such, to estimate user's preferences on the attributes, represented as m, the inquiry manager 226 obtains the user feedback provided in response to the inquiry(s) presented to the user. The user feedback is then used to adjust the appropriate attribute interest values. For example, in cases in which an inquiry requests a preference of attribute A or attribute B, the attribute interest values representing a first attribute and a second attribute are modified in accordance with the user feedback provided in response to the inquiry. By way of example only, assume a user selects a preference of the first attribute. In such a case, the β₁ can be updated to a 1 and β₂ can be updated to a −1 to reflect such a preference.

As described, any values may be used to indicate interest associated with an attribute. As one example, assume an inquiry is a rating inquiry. A rating inquiry may be used to elicit feedback primarily on one attribute. In such a case, response options may be important, not important, and neutral. In cases in which a user responds with “neutral,” the current importance score of the corresponding attribute is preserved. In cases in which a user responds with “important,” the Boolean indicator β of the attribute may be positive (e.g., a 1 value). In cases in which the user responds with “Not Important”, β for the attribute may be negative (e.g., −1). As another example, assume an inquiry is a comparison inquiry. A comparison inquiry may be presented when the optimization direction depends on the choice of two attributes, which asks the user to compare two attributes and select the one that is relatively more important. The selected or preferred attribute may be assigned a positive value (e.g., 1), while the unselected attribute may be assigned a negative value (e.g., −1). Similarly, for a multiple choice inquiry (e.g., request a preference on multiple attributes simultaneously), a selected attribute may be assigned a positive value (e.g., 1), while the remaining or unselected attributes assigned a negative value (e.g., −1).

Upon updating or assigning the appropriate attribute interest values, such values may be stored and/or used to identify a reduced set of candidate data stories, as described more fully below in relation to the recommendation manager.

As described herein, and more fully discussed below, in some implementations, inquiry selection is performed in an iterative manner. In this regard, a single candidate inquiry may be selected for presenting to the user and, upon obtaining a response, a next or subsequent candidate inquiry may be selected for presenting to the user. In this way, the inquiries are selected and presented in a conversational manner in that an inquiry is presented based on a previous inquiry and response thereto. For example, upon selecting an inquiry and presenting the inquiry to the user, a user response is obtained and used to reduce the set of candidate data stories. The reduced set of candidate data stories can then be used to select a next inquiry for presenting to the user. Such an iterative approach may be implemented until a desired outcome is reached (e.g., a predefined or maximum number of inquiries presented to a user, a set of candidate data stories being below a threshold number, etc.).

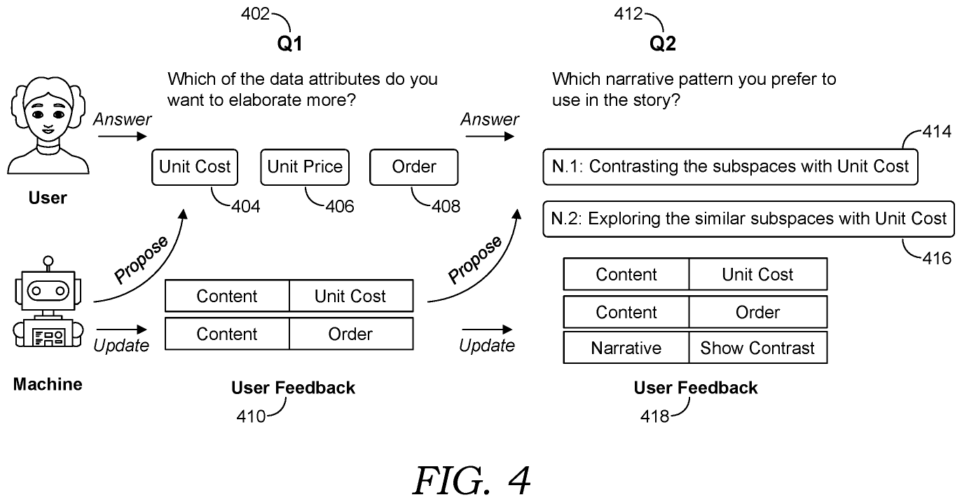

By way of example only, and with respect to FIG. 4, FIG. 4 illustrates a first inquiry 402 presented to the user. The first inquiry 402 asks the user which of the data attributes the user wants to elaborate on more. The first inquiry 402 includes three response options unit cost 404, unit price 406, and order 408. Assume the user selects the unit cost 404 and the order 408. In such a case, the set of user feedback 410 is updated to include the selected attribute preferences. The set of user feedback 410 may be used to reduce a set of candidate data stories, which can then be used to select a second inquiry 412. The second inquiry 412 requests the user to select a preferred narrative pattern and includes two response options, including a contrast response option 414 and an exploration response option 416. Now assume the user selects the contrast response option 414. In such a case, the set of user feedback 418 is updated to include the selected attribute preference.

The recommendation manager 228 is generally configured to generate data story recommendations. As described, a data story recommendation refers to a recommendation of a data story, which may include any number of data visualizations to convey the data story. In embodiments, the recommendation manager 228 uses user feedback provided in response to selected inquiries to facilitate generation or identification of a data story recommendation. In particular, user feedback can be used to reduce the set of candidate data stories available for providing as a data story recommendation. That is, based on user feedback, candidate data stories that do not support the user feedback are removed from the set of candidate stories, thereby reducing the number of candidate data stories available for providing as a data story recommendation. In accordance with attaining a suitable number of remaining candidate data stories, one or more of the remaining candidate data stories can be selected to recommend as a data story.

In embodiments, to identify candidate data stories to remove from the set of candidate data stories, or to identify candidate data stories to maintain as an available candidate data story, the recommendation manager 228 may determine alignment indicators. An alignment indicator generally refers to a value or other indication indicating an extent that a candidate data story aligns with user feedback, such as user feedback m described herein.

In one implementation, to evaluate the alignment of a candidate data story s using user feedback m, an alignment indicator in the form of an alignment reward (e.g., rⱼ^{s}→[0,1]) for each attribute lⱼ is determined. Stated differently, to compare various attributes with those in a candidate data story s, an alignment reward r^{s} is determined for the various attributes. In one implementation, an alignment reward is generated by aggregating the user feedback, or preferences, m that includes the desired attributes and vice versa: r^{s}=|{lⱼ∈m}∩{lⱼ∈s}| where r^{s} corresponds to the intersect of the attributes in the user's feedback set m and the candidate data story's involved attributes {lⱼ∈s}. This example provides a reward of a data story on one attribute. In embodiments, the reward for a data story can be the sum of rewards on all attributes.

By way of example only, assume an attribute lⱼ representing the United States is included in, or associated with (e.g., via at least one data visualization) in a candidate data story s. Further assume that the attribute lⱼ representing the United States is also reflected in the user feedback m as an attribute of interest. In such a case, the alignment reward or indicator may be identified as a one or otherwise indicate alignment between the candidate data story s and the user feedback m. On the other hand, assume the user feedback m indicates the United States is of interest, but the United States is not included in, or associated with the candidate data story s. In such a case, the alignment reward or indicator may be identified as a zero or otherwise indicate there is no alignment between the candidate data story s and the user feedback m. In this regard, the alignment indicator or reward is one, or otherwise indicates alignment, when both the user feedback indicates an interest in an attribute and the candidate data story includes the attribute (e.g., via one or more data visualizations).

In some cases, alignment indicators for content attributes may be determined similarly or differently than alignment indicators for structure attributes. As one example, the alignment reward determination described above may be used similarly for both content attributes and structure attributes, but for structure attributes, the user's feedback on narrative patterns may be added as {pattern, c} where each c∈{C1,C2,C3,C4} represents an individual narrative pattern. Narrative patterns may include showing contrast (e.g., emphasizing differences between data facts to create ‘highlight’ effect), showing accumulative significance (e.g., aiming to heighten the audience's excitement by repeating facts with similar meanings progressively), showing a decisive moment (e.g., attempts to captivate the audience by highlighting crucial temporal points in the data facts), and/or showing ranking (e.g., presenting data in ranked order, engaging the audience through a series of related facts about the ranked items). By way of example, assume illustrating contrast is a desired attribute indicated by the user feedback. In cases in which a candidate data story shows contrast, the alignment indicator can be assigned as a one or positive value.

In accordance with identifying alignment indicators or rewards for desired attributes in association with candidate data stories, the alignment indicators can be used to determine a reduced set of candidate data stories. In this way, a reduced set of candidate data stories that align best with the user feedback is identified based on the alignment indicators. In some implementations, identifying the reduced set of candidate data stories, S* given m, is a multi-objective optimization problem with the goal of maximizing the reward for each attribute. In this regard, in some embodiments, Pareto optimization is employed to extract the Pareto frontier that represents a reduced set of candidate data stories, S*, that can best or most optimally satisfy the user feedback, m. In the context of multi-objective optimization, the Pareto frontier is defined as the set of solutions that are not dominated by any other solution in the search space. A solution dominates if it is better in at least one objective while being equal or better in all other objectives than all possible solutions. In the context of data story recommendations, a candidate data story s dominates if it has better alignment rewards on at least one attribute l∈m. As such, the optimal or reduced set of candidate data stories S* can be expressed as the Pareto frontier given m:

$${S}_{m}^{*} = \{ s \vert s , {s}^{′} ∈ S , s \neq {s}^{′} , ∃ l ∈ m , {r}_{l}^{s} > {r}_{l}^{{s}^{′}} \}$$

In some cases, if a data story s is in the Pareto frontier, then for at least one attribute, l, the data story s has a greater reward than the other data stories s′. In some cases, the size of the Pareto frontier can be negatively correlated with the size of the objectives (e.g., attributes).

As described herein, in some implementations, analysis of candidate data stories to reduce the set of candidate data stories is performed in an iterative manner. In this regard, in accordance with obtaining user feedback and updating the user feedback data, the candidate data stories can be analyzed to identify candidate data stories that align with the user feedback. For example, upon selecting an inquiry and presenting the inquiry to the user, a user response is obtained and used to reduce the set of candidate data stories. The reduced set of candidate data stories can then be used to select a next inquiry for presenting to the user. Such an iterative approach may be implemented until a desired outcome is reached (e.g., a predefined or maximum number of inquiries presented to a user, a set of candidate data stories being below a threshold number, etc.).

In this regard, in some embodiments, when no user feedback is available, all candidate data stories are included in the Pareto frontier. As iterative user feedback is collected, the Pareto frontier size gradually reduces until only a limited number of story candidates remain. In particular, the alignment indicator(s) or reward(s) for each candidate data story is determined in accordance with each obtained user feedback. In this regard, the recommendation manager 228 recomputes the alignment reward for each story candidate with the updated user feedback m and generates a new Pareto frontier for a new round of “refinement-automation” (i.e., question-feedback) loop. In embodiments, the candidate data stories continue to be filtered based on obtained user feedback in response to inquiries until, for example, the size of the Pareto frontier falls below a predefined threshold or the number of question-feedback loops reaches the upper limit. As one example, a threshold for a size of the Pareto frontier may be five (e.g., to reduce the candidate data stories down to five or fewer). As another example, a maximum number of inquiries to present may be ten (e.g., such that ten or less inquiries are presented to the user), thereby avoiding overwhelming a user with excessive inquiries.

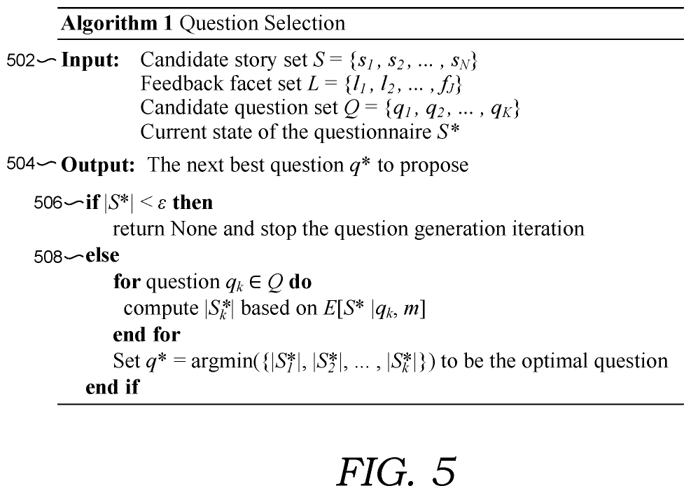

One example of an iterative process is illustrated with reference to the algorithm presented in FIG. 5. As shown, various inputs 502, such as the candidate data story set S, attributes set L, candidate inquiries Q, and current state of the Pareto frontier S* (current set of candidate data stories), are provided to determine the output 504 of a next best inquiry q* to propose. In this example, if the number of candidate data stories in the Pareto frontier is less than a threshold value, the iterative process is ended, as shown at 506 (e.g., one or more of the remaining candidate data stories can be provided for display to a user as a data story recommendation). On the other hand, as shown at 508, if the number of candidate data stories in the Pareto frontier is not less than a threshold value, candidate inquiries are analyzed to identify an optimal inquiry to provide to the user. Based on a response to the candidate inquiry, the Pareto frontier is updated such that the candidate data stories remaining in the Pareto frontier align with the current state of the user feedback.

In embodiments, such an example algorithm has an adequate scalability to a large question set with a time complexity of O(KN), where K is the size of the question set and N is the size of the candidate set. The space complexity is O(N+J+K). With excessively large datasets, the candidate data story set can be trimmed to accommodate efficiency requirements. Additionally, the scalability of the algorithm may be impacted by the attribute size, which may be based at least in part on the number of data columns in the dataset. In some cases, a lower bound is established on the convergence rate, denoted as σ, in a user session. This lower bound can be calculated as

$$= {min}_{i = 1 , i \leq T} \frac{E [ {S}_{i}^{*} ]}{{s}_{i}} ,$$

where T represents the number of turns in the session. The iteration terminates when the size of the story candidate set, |Si|, falls below a predefined threshold ε. By analyzing the convergence condition, an upper bound can be derived on the number of turns given by

$$T \geq \frac{ln ( {S}_{0} )}{ln ( ϵ )} ,$$

where S₀ is the initial story candidate set. As such, the example algorithm exhibits a logarithmic convergence rate, ensuring scalability even for large datasets. In embodiments, convergence may typically occur within 6 iterative inquiries.

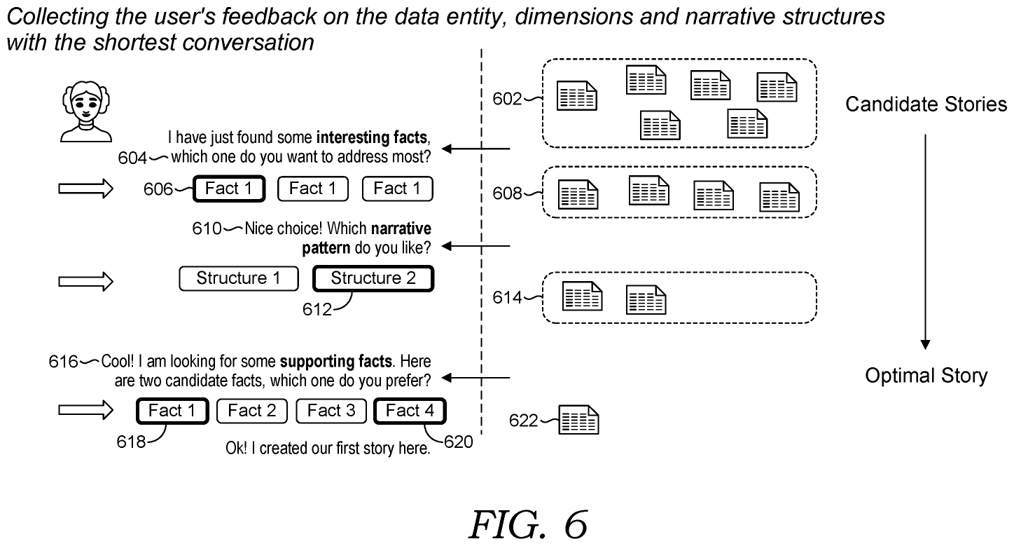

FIG. 6 provides an illustration of an iterative process that may be employed in accordance with embodiments described herein. In this example, assume a set of candidate data stories 602 is generated in association with a data set. Further assume that a first inquiry 604 is selected and presented to a user. The first inquiry 604 asks about interesting facts and presents three different response options. As described herein, the first inquiry 604 can be selected based on the expected reduction in size of the set of candidate data stories. That is, the first inquiry 604 is expected to reduce the size of the candidate data stories 602 the most based on an average of size reductions associated with fact 1, fact 2, and fact 3 presented as response options. Assume the user selects fact 1 606 as the fact of most interest, from among the three facts presented. In such a case, based on the selected fact 1 606, the set of candidate data stories 602 is reduced in size to the set of candidate data stories 608. As can be appreciated, the data stories in the set of candidate data stories 608 align with the selected fact 1 606. Based on the set of candidate data stories 608, a second inquiry 610 is selected. In particular, the second inquiry 610 can be selected based on the expected reduction in size of the candidate data stories 608. In this regard, the second inquiry 610 is expected to reduce the size of the candidate data stories 608 the most based on an average of size reductions associated with structure 1 and structure 2 presented as response options. Assume the user selects structure 2 612 as the preferred narrative pattern, from among the structures presented. In such a case, based on the selected structure 2 612, the set of candidate data stories 608 is reduced in size to the set of candidate data stories 614. As can be appreciated, the data stories in the set of candidate data stories 614 align with the selected structure 612. Based on the set of candidate data stories, 614, a third inquiry 616 is selected and presented. In particular, the third inquiry 616 can be selected based on the expected reduction in size of the candidate data stories 614. Now assume, the user selects response options 618 and 620. Based on the user feedback selecting fact 1 618 and fact 4 620, the candidate data story 622 is selected to provide as a recommended data story.

Returning to FIG. 2, in accordance with reducing the set of candidate data stories to a suitable size or number (e.g., below a threshold number of data stories or upon receiving feedback in response to a maximum number of inquiries), the recommendation manager 228 may select one or more remaining candidate data stories to present as recommendations. In this way, the recommendation manager 228 may provide data stories recommendations when reducing the candidate data story dataset has completed (e.g., reaching a threshold size or a threshold number of inquiries). For example, assume a Pareto frontier has been reduced to five candidate data stories.

In some cases, each of the remaining candidate data stories may be selected to provide as data story recommendations. By way of example, assume five remaining candidate data stories exist. In such a case, each of the five candidate data stories may be selected for presenting as recommendations to a user.

In some cases, a particular candidate data story(s) may be selected (e.g., from among a remaining set of candidate data stories) as a recommendation when candidate data story dataset reduction has completed. For example, assume a Pareto frontier has been reduced to five candidate data stories and a single data story recommendation is desired. In such a case, one of the five remaining candidate data stories may be selected to be presented as a data story recommendation. Selection of a particular data story recommendation may be performed in a number of ways. As one example, alignment indicators or rewards, as described above, associated with the remaining candidate data stories may be used to select a particular candidate data story. For instance, alignment rewards associated with different attributes may be averaged and the candidate data story having a highest average alignment reward may be selected. As another example, a data story candidate may be selected based on a greatest number of “best” alignment rewards. For instance, assume two candidate data stories remain. Further assume the first candidate data story has higher alignment rewards in association with three attributes and the second candidate data story has higher alignment rewards in association with one attribute. In such a case, the first candidate data story is selected to recommend.

The data story provider 224 is generally configured to provide the recommended data story(s). In this regard, the data story provider 224 may provide, as output data 260, a data story recommendation 262 to a device, such as user device 110 of FIG. 1. The data story recommendation may be provided in any of a number of formats. As one example, in cases in which multiple data stories are provided as recommendations, the data story recommendations may be provided concurrently or sequentially (e.g., via scrolling implementation). As another example, the data visualizations of a data story recommendation may be presented in a sequential order, for instance, in a horizontal manner or a vertical manner.

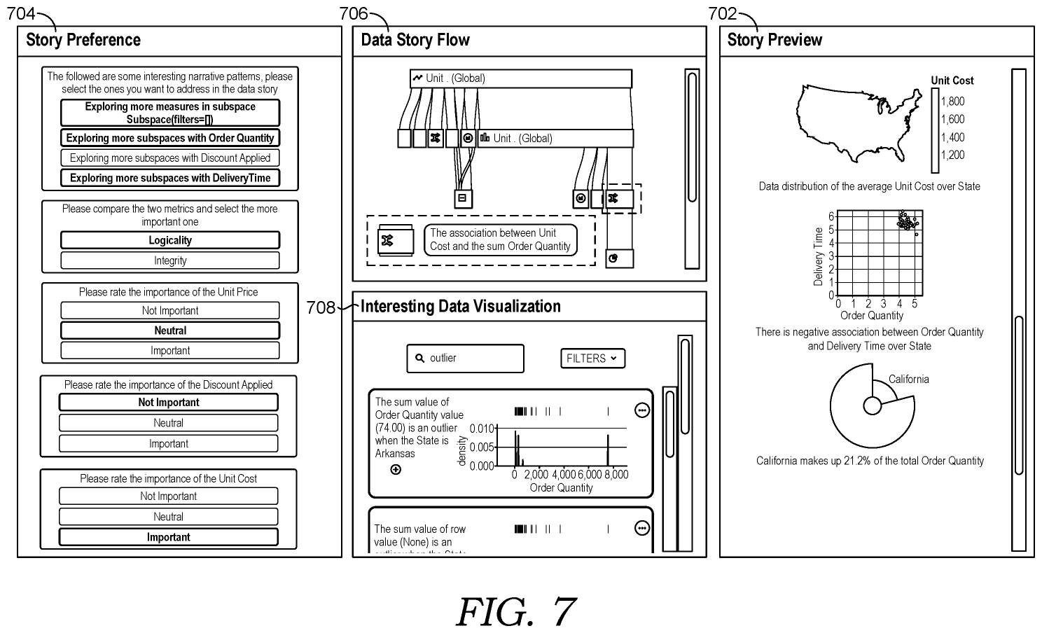

By way of example only, and with reference to FIG. 7, FIG. 7 provides an example graphical user interface that includes a data story recommendation. In particular, the data story recommendation 702 may be presented in response to presentation of a set of inquiries and reception of a set of responses to the inquiries. The set of inquiries and the selected responses may be presented in the story preference 704 portion of the graphical user interface. In this regard, the story preference view collects user feedback and preferences through a conversation workflow. As described herein, the inquiries may be presented in a sequential manner, with each iterative inquiry selected and presented upon receiving a response to a prior inquiry.

In addition to presenting a data story recommendation upon completion of the inquiry conversation, in some cases, a story view 706 may also be presented. A story view 706 presents the story's data visualizations and their narrative relations. A user can explore the story flow and modify the data story 702. In some cases, a flow-chart represents the structure of the data story, as well as alternative data visualizations that could be added to the data story. Each node may represent a data visualization, and the width may encode the score of the narrative transition between two connected facts. Interesting data visualizations 708, or data visualization library, presents possible data visualizations and allows the user to manually refine the data story 702. In some cases, data visualization library enables searching and filtering of data visualizations interactively. The data visualization library may be presented initially (e.g., before the inquiry conversation) or following the inquiry conversation.

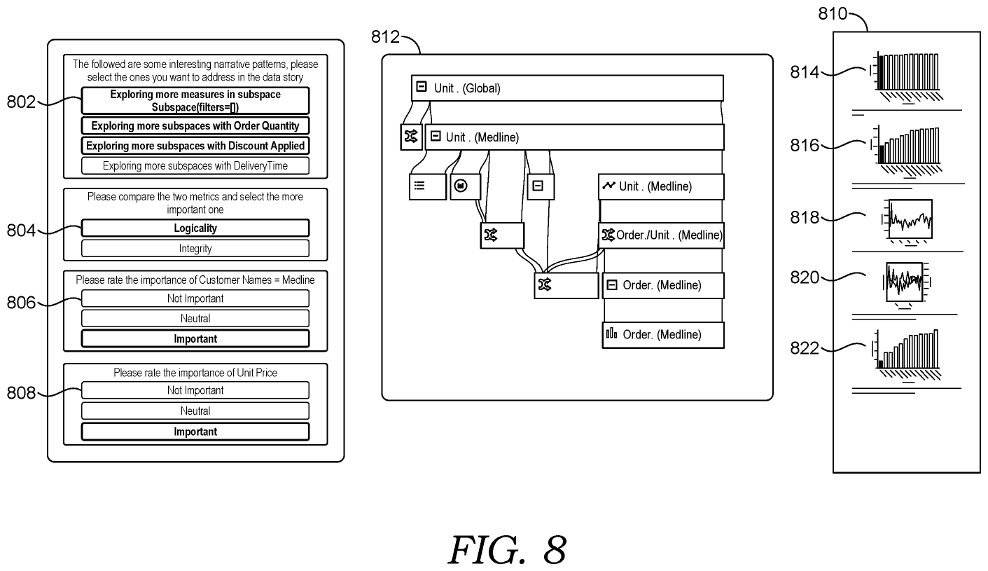

Turning to FIG. 8, FIG. 8 provides another example implementation, in accordance with embodiments described herein. In this example, assume a business analyst, from a B2B e-commerce company, desires to analyze regional sales data to create a report. Upon starting the system, the business analyst uploads the appropriate dataset. In some cases, the business analyst may initially be presented with a list or set of interesting data visualizations displayed in an interesting data visualizations view. As the business analyst gets oriented, the system can generate data story candidates and prepare the first inquiry in the back-end. For the first inquiry 802, feedback on the narrative patterns the business analyst may be interested in is requested. In particular, the first inquiry 802 may include response options, such as exploring numerical attributes under the global subspace (option 1) or exploring the subspace for certain measures (i.e., order quantity, discount, or delivery time, corresponding to options 2-4), as shown in FIG. 8. In this example, the business analyst decides that exploring more measures in subspace, order quantity, and discount are important to look into, but the analyst is not interested in the delivery time. After the business analyst selects the first three options, the system further presents a second inquiry 804 to obtain feedback on which quality metric is more important: logicality or integrity. Assume logicality is selected. Then, the third inquiry 806 is presented to rate the importance of a customer “Medline” and, thereafter, the fourth inquiry 808 is presented to understand the importance of the attribute unit price. Knowing that “Medline” is a valuable cooperation partner of the company, and unit price is closely related to the KPIs of the company, the business analyst marks both as “important.” Having narrowed down the search space of possible candidate data stories, the system stops asking questions and instead analyzes the remaining data stories that reflect the user feedback. The most recommended data story 810 is now displayed, for example, in a story preview portion of the display, while alternative data stories are summarized in the data story flow view 812. From the data story recommendation 810, the business analyst can see that the data story starts with a first data visualization 814 (e.g., including global overview of the average unit price and highlights that the minimum average unit price occurred in November 2020). The data story then includes a second data visualization 816 (e.g., drills down into the data for “Medline” customers, with the lowest unit price occurring in March 2019). A third data visualization 818 is also included (e.g., the analyst can also see that compared to the average unit price, “Medline” purchased products at a much lower price). A fourth data visualization 820 is also provided (e.g., to show an association between the unit cost and the order quantity and shows that the customer had the minimum order quantity in April 2019). The data story ends with a fifth data visualization 822 (e.g., illustrating a distribution of order quantity over the month, showing that the number of orders from Medline” exceeded 30 for more than half of the months). The business analyst can also explore alternative data stories from the data story flow view 812 and tweak the recommended data story by making direct edits from the story preview or by adding data visualizations from the interesting data visualizations pane. For example, a geographic distribution about the unit prices is an alternative data visualization that may be selected.

### Exemplary Implementations for Facilitating Generation of Data Story Recommendations Via User Feedback

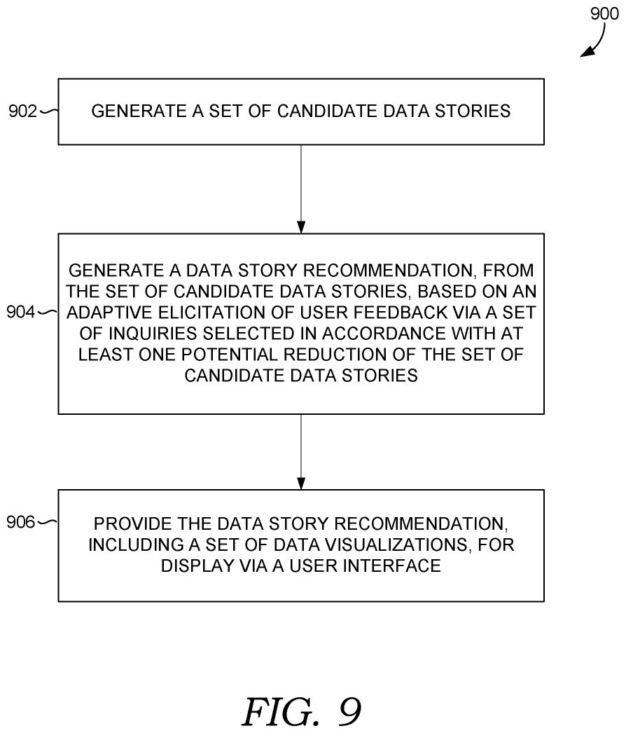

As described, various implementations can be used in accordance with embodiments described herein. FIGS. 9-12 provide methods of facilitating data visualizations based on natural language queries, in accordance with embodiments described herein. The methods 900, 1000, 1100, and 1200 can be performed by a computer device, such as device 1300 described below. The flow diagrams represented in FIGS. 9-12 are intended to be exemplary in nature and not limiting.

Turning initially to method 900 of FIG. 9, method 900 is directed to one implementation of facilitating generation of data story recommendations via user feedback, in accordance with embodiments of the present technology. Initially, at block 902, a set of candidate data stories is generated. In embodiments, a candidate data story includes one or more data visualizations. In some cases, the set of candidate data stories are generated based on a user-selected dataset.

At block 904, a data story recommendation is generated, from the set of candidate data stories, based on an adaptive elicitation of user feedback via a set of inquiries selected in accordance with at least one potential reduction of the set of candidate data stories. In embodiments, the adaptive elicitation of user feedback via a set of inquiries includes a sequence of system-selected inquiries presented to obtain user feedback selecting at least one presented response option. In such a case, each inquiry of the sequence of system-selected inquiries may be subsequently selected based on prior user feedback provided in response to prior presented inquiries. The set of inquiries can include response options related to content of a desired data story and structure of the desired data story. The potential reduction of the set of candidate data stories may be determined by generating expected values for candidate inquiries based on potential reductions of the set of candidate data stories in accordance with potential responses associated with the candidate inquiries.

At block 906, the data story recommendation, including a set of data visualizations, is provided for display via a user interface. In some cases, the data story recommendation is provided concurrently with a plurality of candidate data visualizations for use in modifying the data story recommendation.

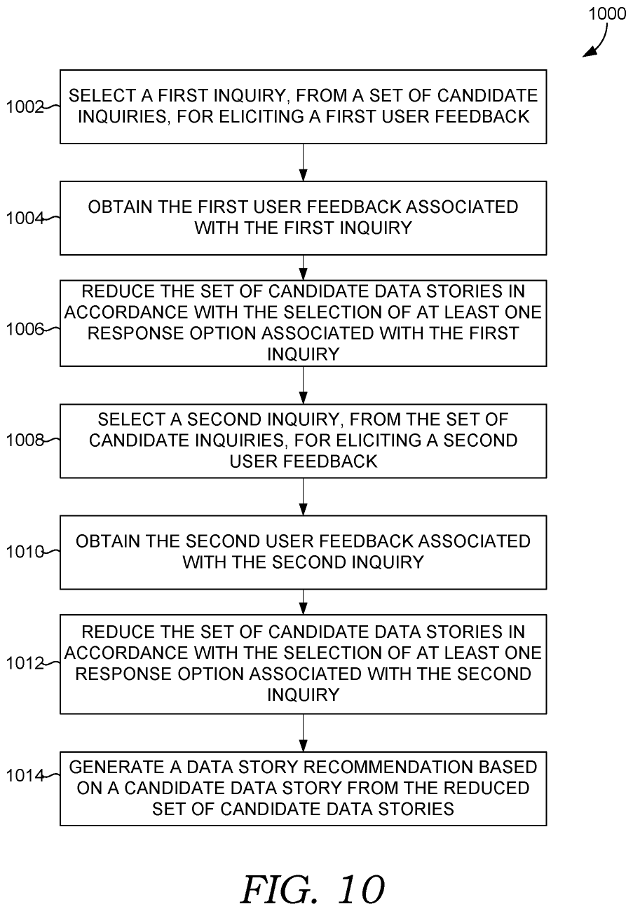

Turning to FIG. 10, method 1000 is directed to another implementation of facilitating generation of data story recommendations via user feedback, in accordance with embodiments of the present technology. Initially, at block 1002, a first inquiry is selected, from a set of candidate inquiries, for eliciting a first user feedback. In embodiments, the first inquiry is selected based on a first potential reduction of a set of candidate data stories in accordance with a first set of potential responses associated with the first inquiry. In some cases, the set of candidate inquiries is generated, for example, based on a dataset for which a data story recommendation is to be generated. Further, the set of candidate data stories, including one or more data visualizations, can be generated in accordance with a dataset.

At block 1004, the first user feedback associated with the first inquiry is obtained. In embodiments, the first user feedback includes a selection of at least one response option associated with the first inquiry. At block 1006, the set of candidate data stories is reduced in accordance with the selection of the at least one response option associated with the first inquiry. In embodiments, reducing the set of candidate data stories includes generating alignment rewards to evaluate alignment of candidate data stories, in the set of candidate data stories, using user feedback for a set of attributes. Such a set of attributes can include content attributes and structure attributes.

At block 1008, a second inquiry is selected, from the set of candidate inquiries, for eliciting a second user feedback. In embodiments, the second inquiry is selected based on a second potential reduction of the reduced set of candidate data stories in accordance with a second set of potential responses associated with the second inquiry. At block 1010, the second user feedback associated with the second inquiry is obtained. In embodiments, the second user feedback includes a selection of at least one response option associated with the second inquiry. At block 1012, the reduced set of candidate data stories is reduced in accordance with the selection of the at least one response option associated with the second inquiry. At block 1014, a data story recommendation is generated based on a candidate data story from the reduced set of candidate data stories. The data story recommendation can be provided for display to a user, for example, that provided the first user feedback and the second user feedback.

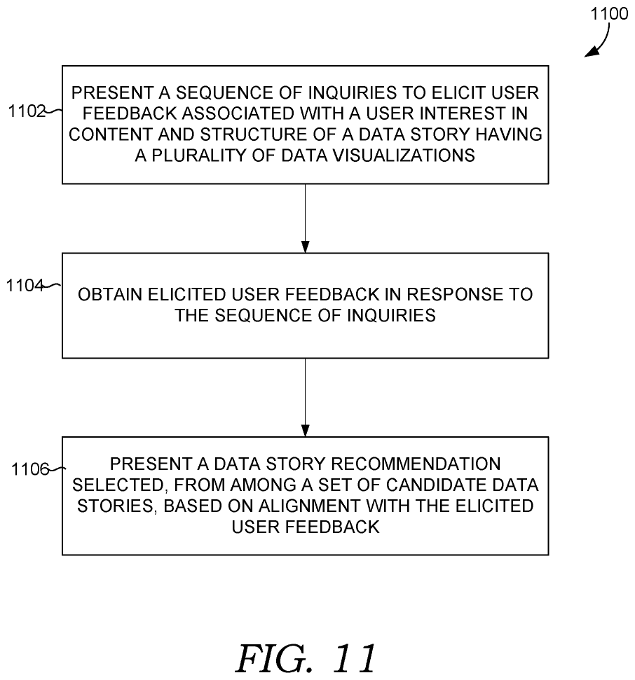

With reference to FIG. 11, method 1100 is directed to another implementation of facilitating generation of data story recommendations via user feedback, in accordance with embodiments of the present technology. Initially, at block 1102, a sequence of inquiries is presented to elicit user feedback associated with a user interest in content and structure of a data story having a plurality of data visualizations. The inquiries may be selected from a set of candidate inquiries generated based on a dataset. In embodiments, an inquiry, of the sequence of inquiries, is selected for display based on an expected value to reduce a candidate set of data stories. Such a candidate set of data stories can be generated based on a user-selected dataset. At block 1104, the elicited user feedback is obtained in response to the sequence of inquiries. At block 1106, a data story recommendation selected, from among the candidate set of data stories, based on alignment with the elicited user feedback in response to the sequence of inquiries is presented. In some cases, in addition to displaying the data story recommendation, a flow chart that represents a structure of the data story recommendation and alternative data visualizations for use in modifying the data story recommendation may also be displayed (e.g., concurrently presented).

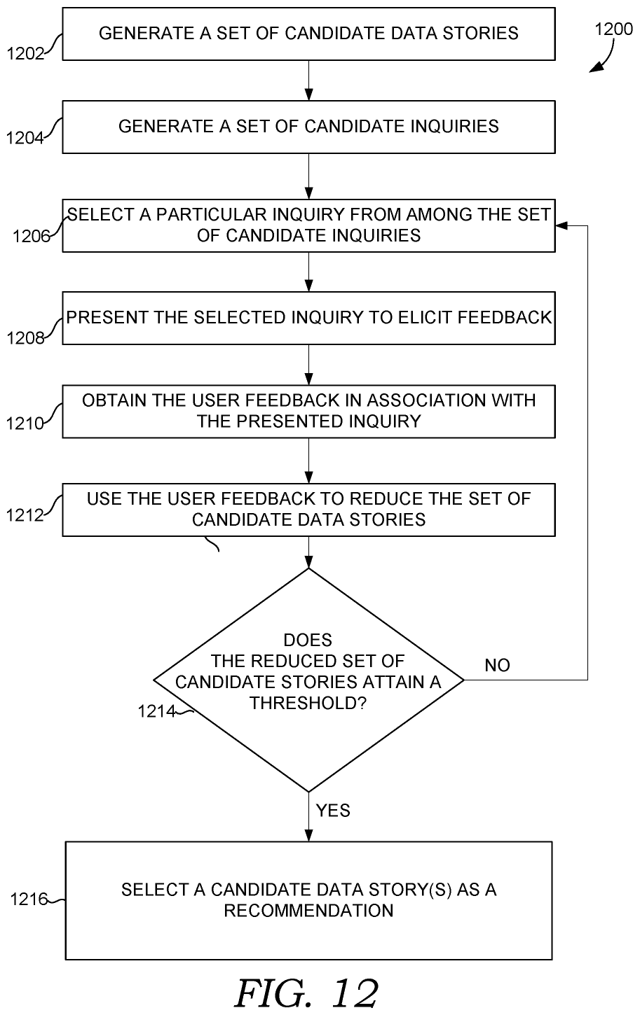

Turning to FIG. 12, method 1200 is directed to another implementation of facilitating generation of data story recommendations via user feedback, in accordance with embodiments of the present technology. Initially, at block 1202, a set of candidate data stories are generated. Candidate data stories can be generated based on a user-selected dataset in any of a number of ways, including utilization of templates to generate various data visualizations. At block 1204, a set of candidate inquiries are generated. Such candidate inquiries may be generated in accordance with various inquiry types (e.g., multiple choice) based on different aspects associated with the dataset and/or structure of a data story. Upon generating candidate inquiries, a particular inquiry may be selected, from among the candidate inquiries, as shown at block 1206. As described, the particular inquiry may be selected based on the inquiry being able to reduce the set of candidate data stories most effectively. For example, a simulation-based approach associated with response options for each candidate inquiry may be used to identify which of the candidate inquiries most effectively reduces the size of the set of candidate data stories. At block 1208, the selected inquiry is presented to the user to elicit feedback. In various examples, the inquiry includes response options from which the user may select a response to provide feedback.

At block 1210, user feedback is obtained in association with the presented inquiry. For example, a user may select one or more response options to indicate interest or preference among various content attributes and/or structure attributes. At block 1212, the user feedback is used to reduce the set of candidate data stories. In this way, candidate data stories that do not align with a set of user feedback (e.g., including new feedback and previous feedback), can be removed from the set of candidate data stories. At block 1214, a determination is made as to whether the reduced set of candidate stories attains a threshold. Such a threshold may be whether the number of candidate stories within the reduced set of candidate stories is below a predetermined number (e.g., under 10 data stories). Another example of a threshold may correspond to a number of inquiries. In this example, a determination may be made as to whether the reduced set of candidate data stories corresponds with a threshold amount of inquiries asked to the user. For instance, if ten or more inquiries have been asked to the user, the determination may be made that the reduced set of candidate stories attains a threshold. If a threshold is attained, at block 1216, a candidate data story(s) is selected as a recommendation. In some cases, one of the remaining candidate data stories may be selected as a data story recommendation. In other cases, each of the remaining candidate data stories may be selected as data story recommendations. On the other hand, if a threshold is not attained, the method returns to block 1206 at which a new inquiry is selected to present to the user. In this case, the new inquiry is selected using the reduced set of candidate data stories. This iterative process repeats until a threshold is attained at block 1214.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 13 in particular, an exemplary operating environment for implementing aspects of the technology described herein is shown and designated generally as computing device 1300. Computing device 1300 is just one example of a suitable computing environment and is not intended to suggest any limitation as to the scope of use or functionality of the technology described herein. Neither should the computing device 1300 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 13, computing device 1300 includes a bus 1310 that directly or indirectly couples the following devices: memory 1312, one or more processors 1314, one or more presentation components 1316, input/output (I/O) ports 1318, I/O components 1320, an illustrative power supply 1322, and a radio(s) 1324. Bus 1310 represents what may be one or more busses (such as an address bus, data bus, or combination thereof). Although the various blocks of FIG. 13 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 13 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 13 and refer to “computer” or “computing device.”

Computing device 1300 typically includes a variety of computer-readable media. Computer-readable media can be any available media that can be accessed by computing device 1300 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1312 includes computer storage media in the form of volatile and/or nonvolatile memory. The memory 1312 may be removable, non-removable, or a combination thereof. Exemplary memory includes solid-state memory, hard drives, and optical-disc drives. Computing device 1300 includes one or more processors 1314 that read data from various entities such as bus 1310, memory 1312, or I/O components 1320. Presentation component(s) 1316 present data indications to a user or other device. Exemplary presentation components 1316 include a display device, speaker, printing component, and vibrating component. I/O port(s) 1318 allow computing device 1300 to be logically coupled to other devices including I/O components 1320, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 1314 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 1300. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 1300. The computing device 1300 may be equipped with depth cameras, such as stereoscopic camera systems, infrared camera systems, RGB camera systems, and combinations of these, for gesture detection and recognition. Additionally, the computing device 1300 may be equipped with accelerometers or gyroscopes that enable detection of motion. The output of the accelerometers or gyroscopes may be provided to the display of the computing device 1300 to render immersive augmented reality or virtual reality.

A computing device may include radio(s) 1324. The radio 1324 transmits and receives radio communications. The computing device may be a wireless terminal adapted to receive communications and media over various wireless networks. Computing device 1300 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive.

What is claimed is:

1. One or more computer storage media having computer-executable instructions embodied thereon that, when executed by one or more processors, cause the one or more processors to perform a method, the method comprising:
generating a set of candidate data stories, wherein each candidate data story comprises one or more data visualizations;
determining a data story recommendation, from the set of candidate data stories, based on an adaptive elicitation of user feedback via a set of inquiries selected in accordance with at least one potential reduction of the set of candidate data stories; and
providing, for display, the data story recommendation including a set of data visualizations.

2. The media of claim 1, wherein the set of candidate data stories are generated based on a user-selected dataset.

3. The media of claim 1, wherein the adaptive elicitation of user feedback via a set of inquiries comprises a sequence of system-selected inquiries presented to obtain user feedback selecting at least one presented response option, wherein each inquiry of the sequence of system-selected inquiries is subsequently selected based on prior user feedback provided in response to prior presented inquiries.

4. The media of claim 1, wherein the at least one potential reduction of the set of candidate data stories is determined by generating expected values for candidate inquiries based on potential reductions of the set of candidate data stories in accordance with potential responses associated with the candidate inquiries.

5. The media of claim 1, wherein the data story recommendation is provided concurrently with a plurality of candidate data visualizations for use in modifying the data story recommendation.

6. The media of claim 1, wherein determining the data story recommendation based on the adaptive elicitation of user feedback via the set of inquiries selected in accordance with the at least one potential reduction of the set of candidate data stories comprises:
selecting a first inquiry, from a set of candidate inquiries, based on a first potential reduction of the set of candidate data stories in accordance with a first set of potential responses associated with the first inquiry;
obtaining a first user feedback associated with the first inquiry, wherein the first user feedback includes a selection of at least one response option associated with the first inquiry;
reducing the set of candidate data stories in accordance with the selection of the at least one response option associated with the first inquiry;
selecting a second inquiry, from the set of candidate inquiries, based on a second potential reduction of the reduced set of candidate data stories in accordance with a second set of potential responses associated with the second inquiry;
obtaining a second user feedback associated with the second inquiry, wherein the second user feedback includes a selection of at least one response option associated with the second inquiry; and
reducing the reduced set of candidate data stories in accordance with the selection of the at least one response option associated with the second inquiry.

7. The media of claim 6, wherein reducing the set of candidate data stories in accordance with the selection of the at least one response option associated with the first inquiry comprises aligning the first user feedback with the reduced set of candidate data stories.

8. The media of claim 1, wherein the set of inquiries include response options related to content of a desired data story and structure of the desired data story.

9. The media of claim 1, wherein the set of inquiries comprise content inquiries requesting interest in content of the data story recommendation and structure inquiries requesting interest in structure of the data story recommendation.

10. A computer-implemented method comprising:
selecting, via the data story engine, a first inquiry, from a set of candidate inquiries, for eliciting a first user feedback, the first inquiry being selected based on a first potential reduction of a set of candidate data stories in accordance with a first set of potential responses associated with the first inquiry;
obtaining, via the data story engine, the first user feedback associated with the first inquiry, wherein the first user feedback includes a selection of at least one response option associated with the first inquiry;
reducing, via the data story engine, the set of candidate data stories in accordance with the selection of the at least one response option associated with the first inquiry;
selecting, via the data story engine, a second inquiry, from the set of candidate inquiries, for eliciting a second user feedback, the second inquiry selected based on a second potential reduction of the reduced set of candidate data stories in accordance with a second set of potential responses associated with the second inquiry;
obtaining, via the data story engine, the second user feedback associated with the second inquiry, wherein the second user feedback includes a selection of at least one response option associated with the second inquiry;
reducing, via the data story engine, the reduced set of candidate data stories in accordance with the selection of the at least one response option associated with the second inquiry; and
generating a data story recommendation based on a candidate data story from the reduced set of candidate data stories.

11. The method of claim 10 further comprising generating, via the data story engine, the set of candidate inquiries based on a dataset for which a data story recommendation is to be generated.

12. The method of claim 10 further comprising providing, via the data story engine, the data story recommendation for display to a user providing the first user feedback and the second user feedback.

13. The method of claim 10, wherein the reducing the set of candidate data stories in accordance with the selection of the at least one response option associated with the first inquiry comprises generating alignment rewards to evaluate alignment of candidate data stories, in the set of candidate data stories, using user feedback for a set of attributes.

14. The method of claim 10, wherein the set of attributes comprise content attributes and structure attributes.

15. The method of claim 10 further comprising generating, via the data story engine, the set of candidate data stories, wherein each candidate data story comprises one or more data visualizations.

16. A computing system comprising:
a processor; and
computer storage memory having computer-executable instructions stored thereon which, when executed by the processor, configure the computing system to:
cause display of a sequence of inquiries to elicit user feedback associated with a user interest in content and structure of a data story having a plurality of data visualizations, wherein an inquiry, of the sequence of inquiries, is selected for display based on an expected value to reduce a candidate set of data stories;
obtain the elicited user feedback in response to the sequence of inquiries; and
cause display of a data story recommendation selected, from among the candidate set of data stories, based on alignment with the elicited user feedback in response to the sequence of inquiries.

17. The system of claim 16, wherein the inquiries of the sequence of inquiries are selected from a set of candidate inquiries generated based on a dataset.

18. The system of claim 16, further configured to generate the candidate set of data stories based on a user-selected dataset.

19. The system of claim 16, further configured to cause display of a flow chart that represents a structure of the data story recommendation and alternative data visualizations for use in modifying the data story recommendation.

20. The system of claim 16, wherein the expected value to reduce the candidate set of data stories is based on an average of expected reductions for the candidate set of data stories in accordance with potential response options associated with the inquiry.
